(19) United States
(12) Patent Application Publication
(10) Pub. No.: US 2017/0151583 A1
(43) Pub. Date: Jun. 1, 2017

(54) Multi-Head Wraparound Tool

(71) Applicant: Walsh Invention Services Ltd, Galway (IE)

(72) Inventor: Paul Walsh, Galway (IE)

(21) Appl. No.: 15/327,188

(22) PCT Filed: Jul. 21, 2015
(86) PCT No.: PCT/IB2015/055517

§ 371 Date: Jan. 18, 2017

(30) Foreign Application Priority Data
Jul. 21, 2014 (IE) 20140173

(51) Int. Cl. B05C 17/02; A46B 5/00; A46D 1/00; B25G 1/10

(52) U.S. Cl. CPC B05C 17/0227; B25G 1/102; B05C 17/0205; A46B 5/0012; A46B 5/0045; A46B 5/0095; A46D 1/0207; A46B 2200/202

(57) ABSTRACT

A multi-head wraparound tool including three working heads includes an elongate handle section, an upper section at one end of the handle including two arms extending away from the upper section in a substantially U shape, a central working head receiving means mounted directly above the upper section between the two arms, two peripheral working head receiving means attached to each arm by a spring loaded hinge; and an actuator mechanism for manipulating the position of the peripheral working heads. The peripheral working head receiving means are spring biased inwardly so that the peripheral working heads form a substantially planar closed triangular configuration with the central working head, with the three working heads wrapped around the item to be cleaned and/or painted.

### INTRODUCTION

The invention relates to a multi-purpose multi-head wraparound tool for cleaning and/or preparing items for painting and for painting items such as bars, posts, poles, shafts, spindles, railings, supports, columns.

Various devices have been designed to try to deal with the awkward task of painting items which have a plurality of surfaces or are substantially circular in cross-section. U.S. Pat. No. 6,045,282 (Begin) describes a tri-roller painting assembly configured to paint simultaneously three surfaces of an object, such as a picket fence, with a continuous supply of paint into the rollers during the painting process. A pair of movable arms are mounted to the upper face portion of the system with each of the arms movable between a first closed position and a second open position. A pair of paint rollers are mounted in parallel relationship to one another and perpendicular to a first roller.

There is however a need for an improved means for preparing an item for painting and/or painting an item in particular items which are substantially circular or rounded in cross section.

### STATEMENTS OF INVENTION

According to the invention there is provided a multi-head wraparound tool comprising three working heads comprising;
an elongate handle section;
an upper section at one end of the handle comprising two arms extending away from the upper section in a substantially U shape;
a central working head receiving means mounted directly above the upper section between the two arms;
two peripheral working head receiving means attached to each arm by a spring loaded hinge; and
an actuator mechanism for manipulating the position of the peripheral working heads;
   wherein the peripheral working head receiving means are spring biased inwardly so that the peripheral working heads form a substantially planar closed triangular configuration with the central working head, with the three working heads wrapped around the item to be cleaned and/or painted.

In one embodiment of the invention the working heads are paint rollers.

In one embodiment of the invention the actuator mechanism comprises an actuator button slidable within a slot on the surface of the handle and connected to the spring loaded hinges on each arm by means of a wire extending internally within the handle and upper section of the tool. Preferably sliding the actuator button in the slot brings the peripheral working heads from a substantially planar closed triangular configuration into an outwardly extending configuration. Most preferably releasing the actuator button causes the peripheral heads to wrap around the surface of an item placed in front of the central head to be cleaned or painted.

In one embodiment of the invention the working head receiving means comprises an elongated pin and the working head is a detachable paint roller which fits tightly over the elongated pin.

In one embodiment of the invention the pin receiving means for the central working head is hinged.

In another embodiment of the invention when the peripheral heads are drawn back fully on their hinges to form a fully open substantially linear configuration.

According to another embodiment of the invention the working heads on the multi-head wraparound tool are wire brushes.

In one embodiment of the invention the working head receiving means comprises a frame and the working head is a detachable wire brush which engages with the frame.

In one embodiment of the invention the actuator mechanism for manipulating the position of the peripheral working heads comprises a tab lever on each working head receiving means. Preferably compressing the tab levers moves the peripheral heads from a substantially planar closed triangular configuration to an open position. Most preferably releasing the tab levers causes the peripheral heads to wrap around the surface of an item placed in front of the central head to be cleaned.

In one embodiment of the invention the handle and upper section of the tool is of unitary construction.

In one embodiment of the invention the three heads act in unison.

In another embodiment of the invention the three heads act in the same plane.

In one embodiment of the invention the tool is ergonomically shaped.

In one embodiment of the invention the multi-head wraparound tool is manufactured from a moulded plastic material.

### BRIEF DESCRIPTION OF THE INVENTION

The invention will be more clearly understood from the following description thereof with reference to the accompanying drawings in which:

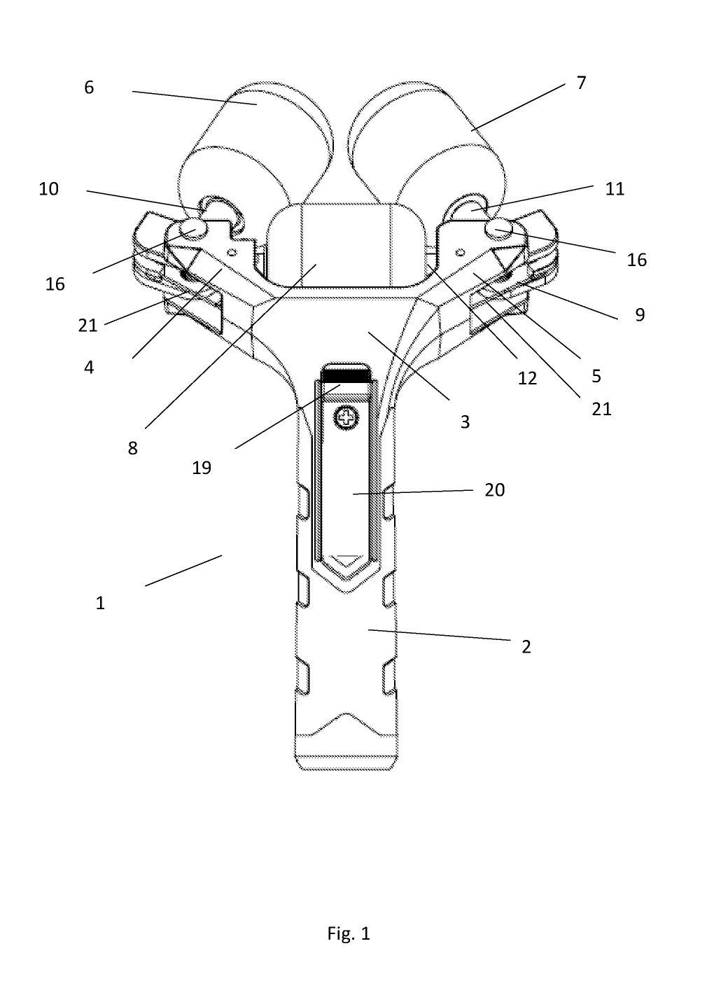

FIG. 1 is a perspective view of a three-headed wraparound tool of the invention;

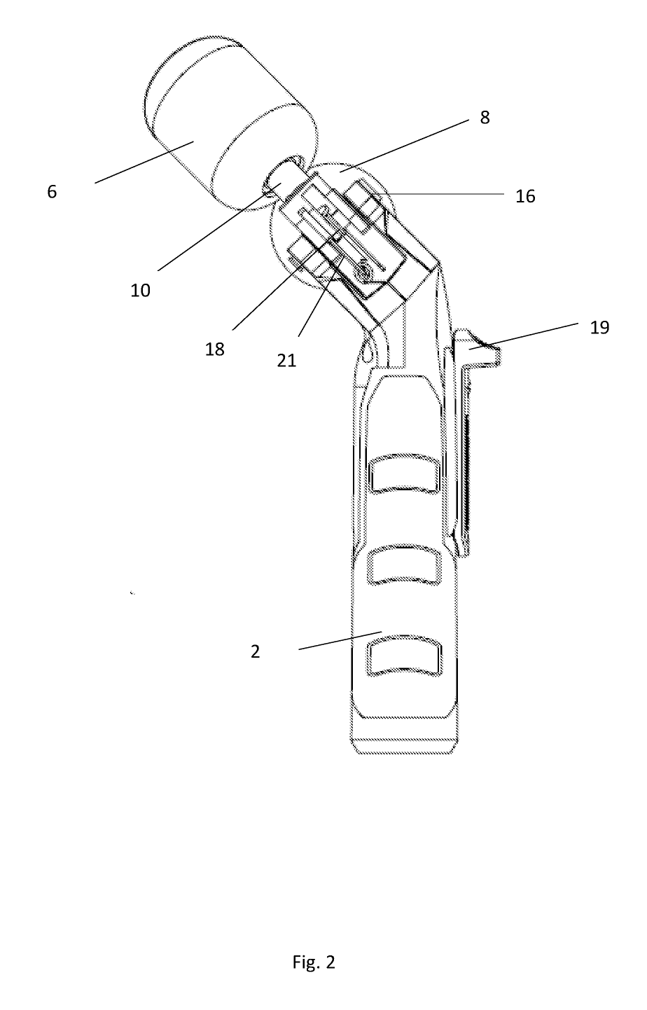

FIG. 2 is a side perspective view of the device of FIG. 1;

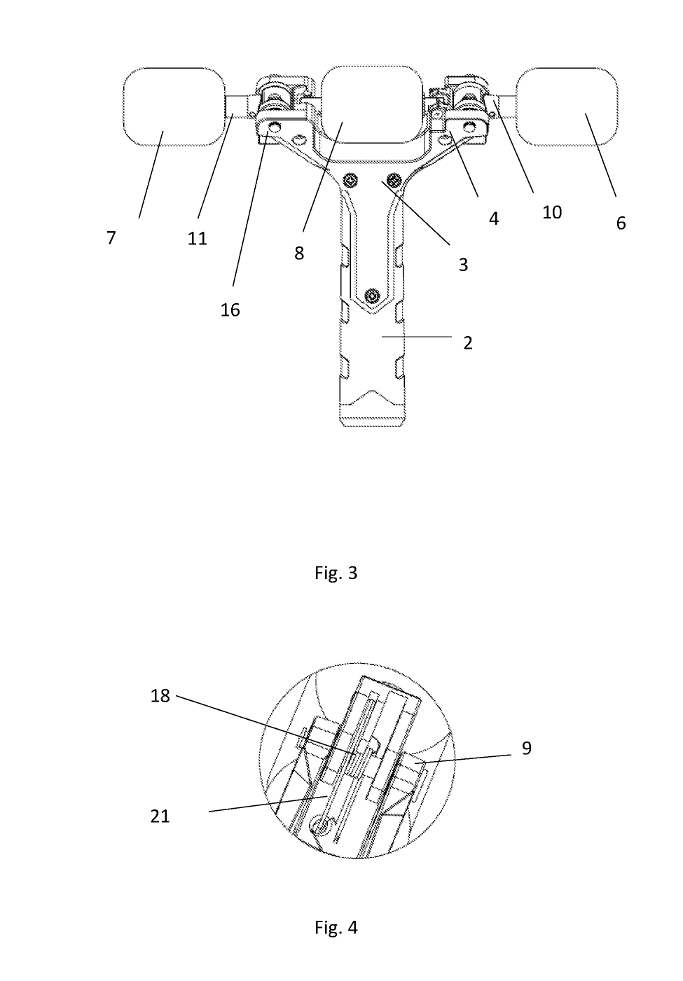

FIG. 3 is a perspective view of the device of FIG. 1 from underneath with its peripheral working heads fully extended in a straight line ready to charge the rollers with paint;

FIG. 4 is an exploded view of the spring mechanism between the peripheral working heads and the arms of the wraparound tool of FIG. 1;

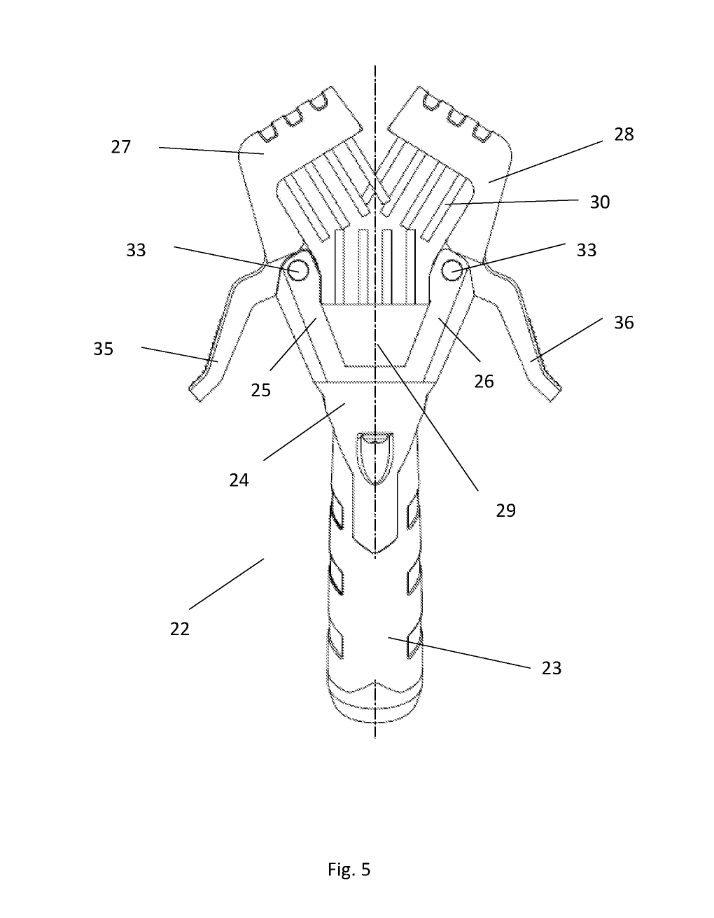

FIG. 5 is a perspective view of a three-headed wraparound device according to another embodiment of the invention;

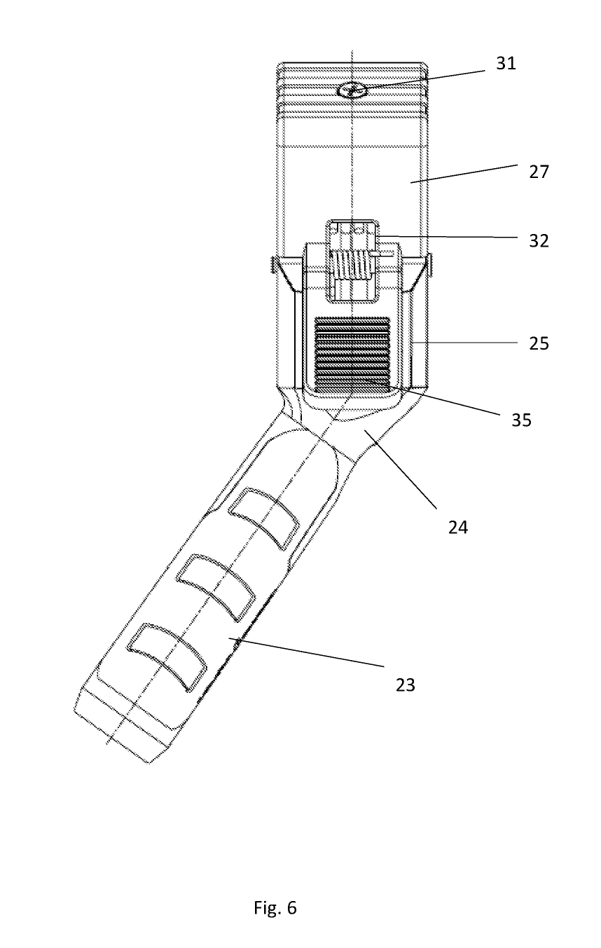

FIG. 6 is a side perspective view of the device of FIG. 5.

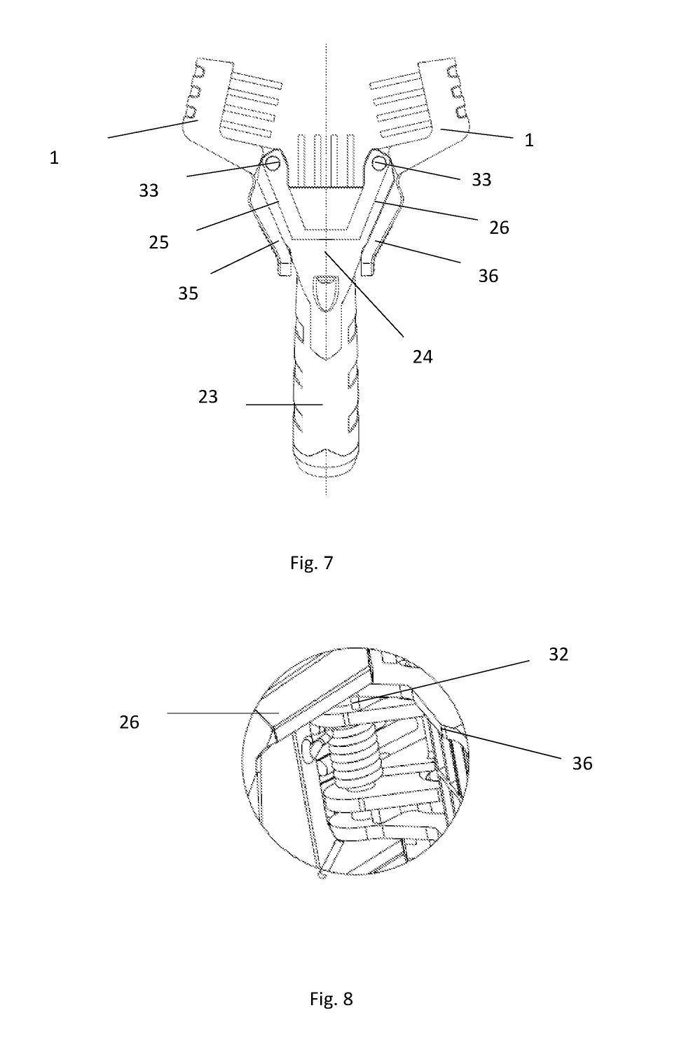

FIG. 7 is a perspective view of the device of FIG. 5 with the peripheral working heads in an open position; and

FIG. 8 is an exploded view of the spring mechanism between peripheral working heads and the arms of the wraparound tool of FIG. 5.

### DETAILED DESCRIPTION

The preparation and painting of items in particular items which are substantially circular or rounded in cross section such as chair legs or gate posts etc is a time-consuming and awkward job. The preparation of surfaces for painting is always a tedious task in particular when the item has awkward to reach sides.

The present invention provides a hand held wraparound tool which has three working heads and the working heads essentially wrap themselves around the item to be cleaned, prepared or painted. The hand held multi-headed wraparound tool may be operated by a user with one hand. Using the hand held tool of the invention, items may be easily and quickly cleaned, prepared and painted.

As shown in FIG. 1 the multi-head wraparound tool 1 of the present invention has an elongate handle section 2 and an upper section 3 at one end of the handle 2 comprising two arms 4, 5 extending substantially away from the handle in a substantially U shape. The tool 1 has three working heads 6, 7 and 8. Peripheral working heads 6, 7 are pivotally attached to each arm 4, 5 and the central working head 8 is attached directly above the upper section 3 between the two arms 4, 5. The multi-head wraparound has a closed triangle configuration. As shown in FIGS. 1 to 4 the working heads in this embodiment are paint rollers.

The working heads 6, 7 and 8 are mounted and supported on elongated pins 10, 11 and 12. The central elongated pin 12 extends between the two arms 4, 5 to support the central working head 8. The two peripheral working heads 6, 7 are mounted on elongated pins 10, 11 pivotally attached to each arm 4, 5 by means of hinges 9. A pivot pin 16 holds each hinge together. The pivot pins are steel. Springs 18 (FIG. 4) are mounted on the hinges 9. The spring loaded hinges 9 ensure the two peripheral working heads 6, 7 are biased inwardly to form a substantially planar closed triangle configuration with the central head 8 as shown in FIGS. 1 and 2. The peripheral working heads 6, 7 are pivotable from an acute angle (FIG. 1) to approximately 180 degrees (FIG. 3) with respect to the central working head.

In this way the paint rollers on the working heads may be charged with paint by rolling the rollers in a conventional paint tray.

The paint rollers slot snugly onto the elongated pins 10, 11, 12. The paint rollers have a hole through their centre with an internal bearing in each. The central elongated pin 12 is hinged at one end and detachably connected at the other end by any suitable means. The elongated pin 12 is opened to remove and/or replace the central paint roller working head 8. The paint roller is rotatably mounted on the central elongated pin 12 and is not movable in any other direction when in its working mode. The central working head rests against a front face of an item to be painted while the peripheral heads wrap around the sides of the item.

The handle section 2 provides a hand holding means to easily hold and operate the tool 1. The upper section 3 is set at an angle of between 140 and 145° in relation to the handle section 2 which makes the tool easy to use and ergonomic. The tool fits comfortably in the hand of the user. The angle of the handle section ensures that the tool is comfortable to operate and the users hand does not necessarily come in contact with the paint.

An actuator mechanism for manipulating the position of the peripheral working heads 6, 7 comprises an actuator button 19 slidable within a slot 20 on the handle section 2. The actuator button 19 is connected to the spring loaded hinges 9 on each arm 4, 5 by means of a wire 21 extending internally within the handle section 2 and upper section 3 of the tool 1. The actuator mechanism causes the two peripheral heads 6, 7 to act in unison.

Sliding and holding the actuator button 19 down along the slot 20 pulls the wires 21 connected to each peripheral arm 4, 5 pulling the spring loaded hinge 9 outward thereby extending the peripheral working heads 6, 7 outwardly and away from the closed triangle configuration with the central working head 8. The peripheral working heads 6, 7 may be fully extended so that they form a substantially linear configuration with the central working head 8 as shown in FIG. 3. The paint rollers may be charged with paint by rolling the rollers in a conventional paint tray. In this configuration the tool may also be used to paint areas which require the use of a straight roller without having to dirty another roller.

To paint an item using the multi-head wraparound tool 1 of the invention the actuator button 19 is moved down within the slot 20 and held by the users thumb so that the peripheral working heads 6, 7 are extended. The area in front of the central working head 8 is thereby opened. The central head 8 of the tool 1 is placed against a first surface of the item to be painted and the actuator button 19 released to allow the spring loaded peripheral heads 6, 7 to move inward towards their closed position. In this way the peripheral paint roller heads are pressed against the sides of the item to be painted. The user then moves the tool 1 longitudinally along the item to paint the object in a single or minimal number of passes. The item may be painted without the user requiring access to all sides of the item as the peripheral heads essentially wrap around the item. For example all sides of a railing may be painted from one side as the central head and peripheral heads are wrapped around the railing post. The multi-head wraparound tool 1 allows the user to quickly and cleanly paint all the surfaces of the item.

The paint roller heads may be easily removed for cleaning or for replacement when required.

Referring now to FIGS. 5 to 7 there is illustrated a multi-head wraparound tool 22 according to another embodiment of the invention. The tool 22 in this embodiment of the invention is used for cleaning items and/or preparing items for painting, for example prior to painting galvanised steel with a coating of paint the surface should be scratched with a wire brush to prepare the surface for painting. In addition when painting on gloss paint the surface need to be scratched with a wire brush to help the new paint to bond.

The multi-head wraparound tool 22 has an elongate handle section 23 and an upper section 24 at one end of the handle section 23 comprising two arms 25, 26 extending substantially away from the handle in a U shape. The tool 22 has three working heads, two peripheral working heads 27, 28 hingedly attached to each arm 25, 26 and a central working head 29 attached to the top of the upper section 24 between the arms 25, 26. As shown in FIGS. 5 to 7 the working heads in this embodiment of the invention are wire brushes 30.

The wire brushes 30 are mounted by any suitable means. The wire brushes may be mounted in position using screws 31 (FIG. 6). Alternatively the wire brushes may be mounted on elongated pins or mounted within holding frames. The wire brushes may be snap fittingly mounted within the frames.

The two peripheral working heads 27, 28 are pivotally attached to the arms 25, 26 by a spring loaded hinge 32 (FIG. 8). A pivot pin 33 holds the hinge together. The pivot pin 33 may be a steel pivot pin. The spring loaded hinge 32 keeps the peripheral working heads 27, 28 supporting the wire brushes 30 biased inwardly towards a closed configuration closing around the item to be cleaned or prepared. The peripheral working heads form a substantially planar closed triangular configuration with the central working head 29.

The actuator mechanism in this embodiment of the invention are tab levers 35, 36 attached to each of the peripheral working heads 27, 28. The two tab levers 35, 36 extend outward and downward down from the spring loaded hinge 32 on each working heads 27, 28. When the levers 35, 36 are pressed they open the peripheral heads 27, 28 and facilitate the placement of the wire brushes around the item to be cleaned. The central working head 29 is placed against a first surface of the item and the tab levers 35, 36 released to wrap the peripheral heads wound the item.

Compressing the levers 35, 36 also allows for the cleaning and/or replacement of the working heads. Releasing the tab levers 35, 36 causes the spring loaded hinges 32 to bring the wire brushes back into a substantially planar closed triangular configuration and close the wire brush heads around the object to be cleaned see FIG. 5.

The handle section 23 attaches to the upper section 24 and provides a hand holding means to facilitate manipulation of the multi-head wraparound tool. The upper section 24 is set at an angle of between 140 and 145° in relation to the handle section 23 which makes the tool ergonomic and easy to use.

From the forgoing, it will be apparent that the present invention with its wire brush working heads is adapted to wrap itself around a longitudinal bar, rod or pole and can move longitudinally there along. The multi-head wraparound tool with its wire brushes can clean an object in a few passes. The item may be cleaned without the user requiring access to all sides of the item in question. The wire brushes on the multi-head wraparound tool may also be used to prepare a surface prior to painting.

The three heads of the multi-head wraparound tool of the present invention operate in unison. The three working heads also operate in the same plane.

The multi-head wraparound tool of the invention is of unitary construction. The tool is preferably manufactured from a moulded plastic material. The elongated handle is ergonomically shaped so as to be comfortable to grip and use.

The invention is not limited to the embodiment hereinbefore described, with reference to the accompanying drawings, which may be varied in construction and detail. Therefore, it is understood that the invention is not to be limited to the specific embodiments disclosed and that modifications and embodiments are intended to be included within the invention.

1-18. (canceled)

19. A multi-head wraparound tool comprising three working heads comprising;
an elongate handle section;
an upper section at one end of the handle comprising two arms extending away from the upper section in a substantially U shape;
a central working head receiving means mounted directly above the upper section between the two arms;
two peripheral working head receiving means attached to each arm by a spring loaded hinge; and
an actuator mechanism for manipulating the position of the peripheral working heads;
wherein the peripheral working head receiving means are spring biased inwardly so that the peripheral working heads form a substantially planar closed triangular configuration with the central working head, with the three working heads wrapped around the item to be cleaned and/or painted.

20. A multi-head wraparound tool as claimed in claim 19 wherein the working heads are paint rollers.

21. A multi-head wraparound tool as claimed in claim 19 wherein the actuator mechanism comprises an actuator button slidable within a slot on the surface of the handle and connected to the spring loaded hinges on each arm by means of a wire extending internally within the handle and upper section of the tool.

22. A multi-head wraparound tool as claimed in claim 21 wherein sliding the actuator button in the slot brings the peripheral working heads from a substantially planar closed triangular configuration into an outwardly extending configuration.

23. A multi-head wraparound tool as claimed in claim 21 wherein releasing the actuator button causes the peripheral heads to wrap around the surface of an item placed in front of the central head to be cleaned or painted.

24. A multi-head wraparound tool as claimed in claim 19 wherein the working head receiving means comprises an elongated pin and the working head is a detachable paint roller which fits tightly over the elongated pin.

25. A multi-head wraparound tool as claimed in claim 24 wherein the elongated pin receiving means for the central working head is hinged.

26. A multi-head wraparound tool as claimed in claim 19 wherein the peripheral heads are drawn back fully on their hinges to form a fully open substantially linear configuration.

27. A multi-head wraparound tool as claimed in claim 19 wherein the working heads are wire brushes.

28. A multi-head wraparound tool as claimed in claim 27 wherein the working head receiving means comprises a frame and the working head is a detachable wire brush which engages with the frame.

29. A multi-head wraparound tool as claimed in claim 27 wherein the actuator mechanism for manipulating the position of the peripheral working heads comprises a tab lever on each working head receiving means and compressing the tab levers moves the peripheral heads from a substantially planar closed triangular configuration to an open position.

30. A multi-head wraparound tool as claimed in claim 29 wherein releasing the tab levers causes the peripheral heads to wrap around the surface of an item placed in front of the central head to be cleaned.

31. A multi-head wraparound tool as claimed in any claim 19 wherein the handle and upper section of the tool is of unitary construction.

32. A multi-head wraparound tool as claimed in claim 19 wherein the three heads act in unison.

33. A multi-head wraparound tool as claimed in claim 19 wherein the three heads act in the same plane.

34. A multi-head wraparound tool as claimed in claim 19 wherein the tool is ergonomically shaped.

35. A multi-head wraparound tool as claimed in claim 19 is manufactured from a moulded plastic material.
